(19) United States
(12) Patent Application Publication
(10) Pub. No.: US 2004/0213458 A1
(43) Pub. Date: Oct. 28, 2004

(54) Image processing method and system

(75) Inventor: Tomotoshi Kanatsu, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/828,470

(22) Filed: Apr. 21, 2004

(30) Foreign Application Priority Data
Apr. 25, 2003 (JP) 2003-121076

(51) Int. Cl. G06K 9/00; G06F 7/00

(52) U.S. Cl. 382/181; 707/3

(57) ABSTRACT

An image processing method and system for search for an original data file corresponding to an input image are provided. According to an image processing method associated with one aspect of the present invention, for example, first search information associated with an input image is acquired on the basis of the information input by a user, and feature data contained in the input image is acquired as second search information. Thereafter, an original data file corresponding to the input image is searched for by using the first and second search information. This makes it possible to improve the search performance in searching for an original data file corresponding to a paper document.

### FIELD OF THE INVENTION

The present invention relates to an image processing method and system and, more particularly, to an image processing method and system which are used to search for an original data file corresponding to an input image.

### BACKGROUND OF THE INVENTION

Amid calls for environmental problems, there has been a rapid progression toward paperless offices.

1. First Prior Art

As a method of promoting paperless operation, there is available a method of scanning paper documents stored in binders and the like with a scanner or the like, converting them into compact files such as portable document format (PDF format) files as raster data images, and storing them in an image storing means (see, for example, Japanese Patent Laid-Open No. 2001-358863).

2. Second Prior Art

As the second method of promoting paperless operation, a method using a printing device with enhanced function such as an MFP (multi-function peripheral) is available. In this method, character and image original files are stored in an image storage device in advance. When an original data file is to be printed on a paper document, pointer information indicating the location of the original data file in the image storage device is printed on the cover sheet of the paper document or in printed information (see, for example, Japanese Patent Laid-Open No. 10-285378). The pointer information allows quick access to the original data file. This makes it possible to reuse, for example, edit or print the original data file, thereby reducing the amount of paper documents to be held.

In the first prior art described above, although the images scanned by the scanner can be stored as a PDF file having a small information amount, the file in which a printed document is stored cannot be searched for from it. This makes it difficult to reuse stored documents.

In the second prior art, if a document file has no pointer information for accessing an original data file, the original data file cannot be searched for.

### SUMMARY OF THE INVENTION

The present invention has been made to solve such problems, and has as its object to search for an original data file on the basis of the image data obtained by scanning a paper document, and more specifically to search for an original data file corresponding to an input image with higher precision.

It is another object to convert the input image into vector data and store it in a database if no original data file can be found.

The above problems can be solved by an image processing method and system according to the present invention. According to an image processing method associated with one aspect of the invention, for example, the first search information associated with an input image is acquired on the basis of the information input by a user, and feature data contained in the input image is acquired as the second search information. Thereafter, an original data file corresponding to the input image is searched for by using the first search information and the second search information. This makes it possible to improve the search performance in searching for an original data file corresponding to a paper document.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which-are incorporated in and constitute a part of the specification, illustrate embodiments of the invention and, together with the description, serve to explain the principles of the invention.

FIG. 1 is a block diagram showing the arrangement of an image processing system according to an embodiment;

FIG. 2 is a block diagram showing the arrangement of a multi-function peripheral (MFP) according to the measurement;

FIG. 3 is a flow chart showing an image processing method according to the embodiment;

FIG. 4 is a view showing an original to be processed by the image processing method according to the embodiment and an image obtained as a result of processing;

FIG. 5 is a view showing the block information obtained by a block selection process and input file information;

FIG. 6 is a flow chart showing the processing of extracting pointer information from an image on an original according to the embodiment;

FIG. 7 is a view showing an image on an original containing pointer information according to the embodiment;

FIG. 8 is a flow chart showing a file search process based on pointer information in the embodiment;

FIG. 9 is a flow chart showing a vectorization process with respect to a character region in the embodiment;

FIG. 10 is a flow chart showing a file search process in the embodiment;

FIG. 11 is a view showing corner extraction processing in a vectorization process in the embodiment;

FIG. 12 is a view showing outline line combining processing in a vectorization process in the embodiment;

FIG. 13 is a flow chart showing a grouping process of the vector data generated by vectorization in the embodiment;

FIG. 14 is a flow chart showing a graphic element detection process with respect to grouped vector data in the embodiment;

FIG. 15 is a view showing the map of data obtained as a result of vectorization in the embodiment;

FIG. 16 is a flow chart showing an application data conversion process in the embodiment;

FIG. 17 is a flow chart showing a document structure tree creation process in the embodiment;

FIG. 18 is a view showing an example of the document to be subjected to a document structure tree creation process in the embodiment;

FIG. 19 is a view showing an example of the document structure tree created by a document structure tree creation process in the embodiment; and

FIG. 20 is a flow chart showing a pointer information addition process in the embodiment.

### DETAILED DESCRIPTION OF THE PREFERRED EMBODIMENT

Preferred embodiments of the present invention will now be described in detail in accordance with the accompanying drawings.

[Image Processing System]

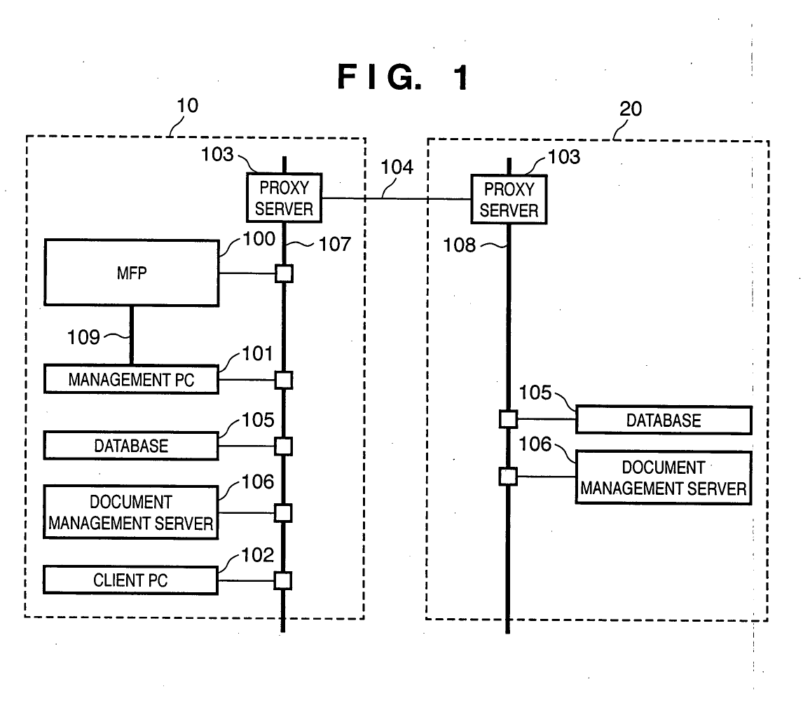

FIG. 1 is a block diagram showing the arrangement of an image processing system according to an embodiment of the present invention. This image processing system is used in an environment in which an office 10 is connected to an office 20 via an Internet 104.

An MFP (multi-function peripheral) 100 serving as a printing device, a management PC 101 which controls the MFP 100, a client PC (external storage means) 102, a document management server 106, and a database 105 for the document management server 106 are connected to a LAN 107 constructed in the office 10.

A LAN 108 is constructed in the office 20. The document management server 106 and the database 105 for the document management server 106 are connected to the LAN 108.

A proxy server 103 is connected to the LANs 107 and 108. The LANs 107 and 108 are connected to the Internet via the proxy server 103.

The MFP 100 takes charge of part of image processing for the input image scanned from a paper document. The image data obtained as the processing result is input to the management PC 101 via a LAN 109. The management PC 101 is a general computer including an image storage means, image processing means, display means, input means, and the like. Some of these constituent elements are functionally integrated with the MFP 100 to form constituent elements of the image processing system. In this embodiment, the management PC executes the search process to be described below. However, the processing executed by the management PC may be executed by the MFP instead.

The MFP 100 is directly connected to the management PC 101 via the LAN 109.

[MFP]

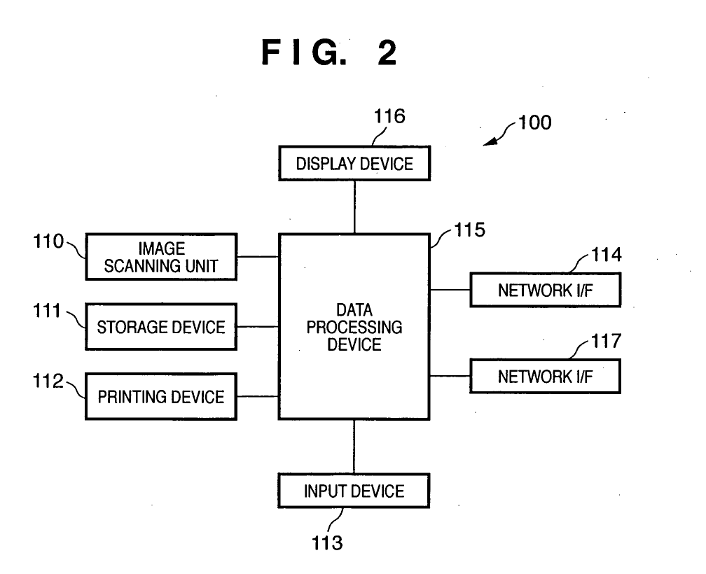

Referring to FIG. 2, the MFP 100 includes an image scanning unit 110 having an automatic document feeder (ADF) (not shown). The image scanning unit 110 irradiates images on a batch of originals or on one original with light from a light source, and forms reflected images on a sold-stage image sensing device. The solid-state image sensing device generates a scanned image signal at a predetermined solution (e.g., 600 dpi) and a predetermined density level (e.g., eight bits). Image data composed of raster data is formed from the scanned image signal.

The MFP 100 includes a storage device 111 and printing device 112. In executing the general copying function, the MFP 100 causes a data processing device 115 to perform image processing of image data to convert it into a printing signal. When images are to be copied on a plurality of sheets, printing signals corresponding to one page are temporarily stored in the storage device 111, and then are sequentially output to the printing device 112, thereby forming printed images on copying sheets.

The MFP 100 includes a network IF 114 for connection to the LAN 107, and can print the image data output from the client PC 102 by using the printing device 112. The image data output from the client PC 102 is sent to the data processing device 115 via the LAN 107 and network IF 114 and is converted into a printing signal, which allows printing, by the data processing device 115. In the MFP 100, the signal is then printed as a printed image on a printing sheet.

The MFP 100 is operated via a key operation unit (input device 113) provided for the MFP 100 or an input device (keyboard, pointing device, and the like) of the management PC 101. For these operations, the data processing device 115 executes predetermined control using an internal control unit (not shown).

The MFP 100 includes a display device 116, and can display the state of operation input and image data to be processed by using the display device 116.

The storage device 111 can be directly controlled from the management PC 101 via a network IF 117. The LAN 109 is used to exchange data and control signals between the MFP 100 and the management PC 101.

[Overall Flow of Processing in Image Processing Method]

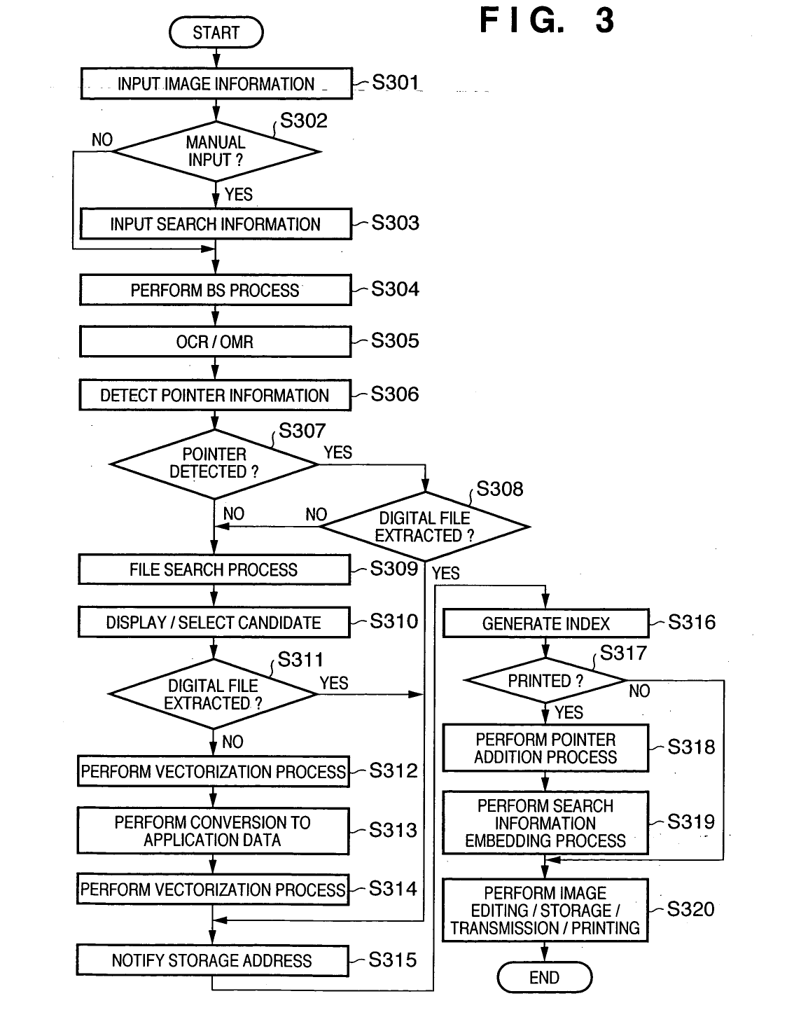

An image processing method according to this embodiment is executed in the respective steps in FIG. 3.

Step S301: The image scanning unit 110 of the MFP 100 is operated to raster-scan one original to acquire a scanned image signal at a predetermined solution and predetermined density level. The data processing device 115 performs pre-processing of the scanned image signal. The resultant data is stored as image data corresponding to one page of the input image in the storage device 111. The flow then advances to step S302.

Step S302: At the same time when image scanning is done, the user is prompted on the operation window 116 to input information for specifying an input image, and it is checked whether or not the user inputs information. If the user inputs information, the flow advances to step S303. If the user does not input information, the flow jumps to step S304.

Step S303: The user manually inputs information for specifying an original data file. The information to be input is information useful for input image search, e.g., a keyword for the input image, the data size of an original data file corresponding to the input image, and the creation date of the original data file.

Step S304 (block selection (region segmentation) step): The management PC 101 is used to segment the region of the image data stored in the storage device 111 into a character/line drawing region including a character or line drawing, a halftone photograph region, an image region in an indefinite shape, and the like. The character/line drawing region is further separated into a character region containing mainly a character and a line drawing region containing mainly a table, graphic, or the like. The line drawing region is separated into a table region and graphic region. In this embodiment, concatenated pixels are detected, and region segmentation is performed for each property by using the shape, size, pixel density, or the like of a circumscribed rectangular region of the concatenated pixels. However, another region segmentation method may be used.

The character region is segmented into rectangular blocks (character region rectangular blocks) each consisting of a chunk of a character paragraph as a block. The line drawing region is segmented into rectangular blocks for each object (table region rectangular block or line drawing region rectangular block) such as a table or graphic.

The halftone photograph region is segmented into rectangular blocks for each object such as an image region rectangular block or background region rectangular block.

The information of such a rectangular block will be referred to as “region segmentation information”.

Step S305: OCR processing and OMR processing are performed to check whether or not the pointer information of the original data file is embedded in the input image.

A two-dimensional barcode printed as additional information in the original image or an object corresponding to a URL is detected. The URL is then character-recognized by an OCR or the two-dimensional barcode is decoded by an OMR, thereby detecting pointer information in the storage device in which the original data file of the input image is stored.

A means for adding pointer information is not limited to a two-dimensional barcode, and includes, for example, a so-called digital watermarking method, e.g., a method of embedding information as a change in adjacent character spacing or a method of embedding a halftone image, i.e., a method of embedding information that is not directly and visually recognized.

Step S306 (pointer information extraction step): Pointer information is extracted from the information obtained by the OCR or OMR or digital watermarking information in step S305.

Step S307: It is checked whether or not the pointer information is acquired in step S306. If pointer information is acquired, the flow branches to step S308 to directly access the original data file.

If no pointer information can be extracted in step S306, the flow advances to step S309.

Step S308: If pointer information is extracted, a search is made for the original data file (digital file) by using the pointer information. The original data file is stored, in the form of a digital file, in the hard disk of the client PC 102 in FIG. 1, the database 105 in the document management server 106, the storage device 111 provided in the MFP 100, or the like. These storage devices are searched according to the address information (pointer information) obtained in step S306. If no original data file is found as a search result, or the extracted original data file is a raster data file, or an image data file obtained by encoding raster data, typified by a BMP file or tiff file, the flow branches to step S309. If the original data file can be extracted, the flow jumps to step S315.

Step S309 (document search process step): If no pointer information is extracted, or no original data file is extracted on the basis of the pointer information, or the extracted original data file is an image data file, keyword search or full-text search is made in the database 105 on the basis of the search information manually input in step S303, the important word extracted by OCR processing in step S305, or the like to obtain a similarity (search score) with a file in the database. In addition, a similarity (search score) with a file in the database is obtained in terms of the object property or layout information extracted by a block selection process, file size or creation date as search information, or the like.

Step S310: The cumulative sum (total search score) of search scores obtained by weighting the search result in step S309 according to each search condition. If a plurality of files exhibiting similarities higher than a predetermined value, the extracted files are displayed as candidate data files in the form of thumbnails or the like on the operation window 116 in descending order of scores, i.e., similarities, thereby prompting the user to select a file. When the user specifies an original data file among the candidate data files by input operation, the data file is specified. If only one candidate data file is extracted, and the total search score is high, the flow may automatically bypass step S310 and jump to step S311. step S311: It is checked whether one original data file is specified in step S309 or S310. If one data file is specified, the flow jumps to step S315. If no data file is extracted, or the extracted data file is an image data file, the flow advances to step S312.

Step S312 (vectorization step): A vectorization process is performed to convert the image data in each specific region into vector data.

Vectorization methods include, for example, methods (a) to (f) as described below.

(a) When a specific region is a character region, a character image code-converted by an OCR or the size, style, and font of a character are recognized to convert the character into font data visually faithful to the character obtained by scanning the original.

(b) When a specific region is a character region, and cannot be recognized by an OCR, the outline of a character is traced to convert the character into a form expressing outline information (outline) as a concatenation of line segments.

(c) When a specific region is a graphic region, the outline of a graphic object is traced to convert the object into a form expressing outline information as a concatenation of line segments.

(d) Fitting of outline information in the line segment form as in (b) and (c) is performed by using a Bezier function to convert the information into function information.

(e) The shape of a graphic is recognized from the outline information of a graphic object in (c) to convert the graphic into graphic definition information about a circle, rectangle, polygon, or the like.

(f) When a specific region is a graphic region and is an object in a table form, ruled lines and frame lines are recognized to convert them into document format information in a predetermined format.

In addition to the above methods, various vectorization methods of replacing raster data with a predetermined command or code information are conceivable.

Step S313: The vector data obtained in step S310 is directly converted into data in an application data format and output. In general, a data format depends on the application to be used, and needs to be converted into a file format in accordance with a purpose.

Application data formats which allow reuse, e.g., editing, are application software such as wordprocessor software and spreadsheet software, including, for example, wordprocessor “WORD” (registered trademark) and spreadsheet application software “EXCEL” (registered trademark) available from Microsoft Corporation. These applications are used for different purposes, and have file formats defined in accordance with the purposes. Files (data) are stored in the respective formats.

As more versatile file formats, for example, the following are known: the RTF (Rich Text File) format available from Microsoft Corporation, the SVG (Scalable Vector Graphics) format which has recently been used, and the plain text format which simply handles only text data. These formats can be commonly used in corresponding applications.

Step S314: The vector data of the vectorized region generated in step S313 and the image data of other regions are stored as digital files in the storage device 111. The image data are stored in, for example, the JPEG format.

Step S315: An address indicating the storage location of data is output. If data is stored in the storage device 111 in step S314, the address of the data stored in the storage device 111 is output. If an original data file is extracted in step S308 or S311, the address of the original data file is output.

Step S316: For the data stored in the database 105 and storage device 111, an index file is created in advance. For the data whose storage locations are determined in the above processing or which are stored in new storage locations, these storage locations are added to the index file.

In addition, in the index file, the word input in step S303 and the word automatically extracted in step S313 are registered. This improves the search performance for the next search.

If an original data file is extracted in step S308 or S311, the word input in step S303 is also additionally registered in the index file. This improves the search performance even in a situation in which no pointer information can be used.

Step S317: The user is prompted to check whether the contents of the detected or created digital file are to be subjected to printing/outputting processing such as printout processing or the like. If printing/outputting processing is to be performed, the flow advances to step S318. If output processing other than printing/outputting processing is to be performed, the flow jumps to step S320.

Step S318: Pointer information is added to the digital file or the like. The pointer information can be added by various known methods including, for example, a method of adding information to an output image in the form of a two-dimensional barcode and a method of embedding a digital watermark in a character string or halftone image.

This makes it possible to acquire the pointer information immediately after the printed image is scanned, and to allow access to the original data file.

Step S319: Information associated with the digital file is added to an output image in addition to the pointer information added in step S318. This information is added by the same method as in step S318. This makes it possible to efficiently search for the original data file even if no pointer information can be used.

Step S320: By using the digital file obtained in the above processing, various types of processing such as manipulation, storage, transmission, and printing of a document are performed. The created or acquired digital file is smaller in data size than an image data file. This produces the effects of improving the storage efficiency, reducing the transmission time, and improving the printing quality.

The main steps in FIG. 3 will be described in detail.

[Block Selection Step]

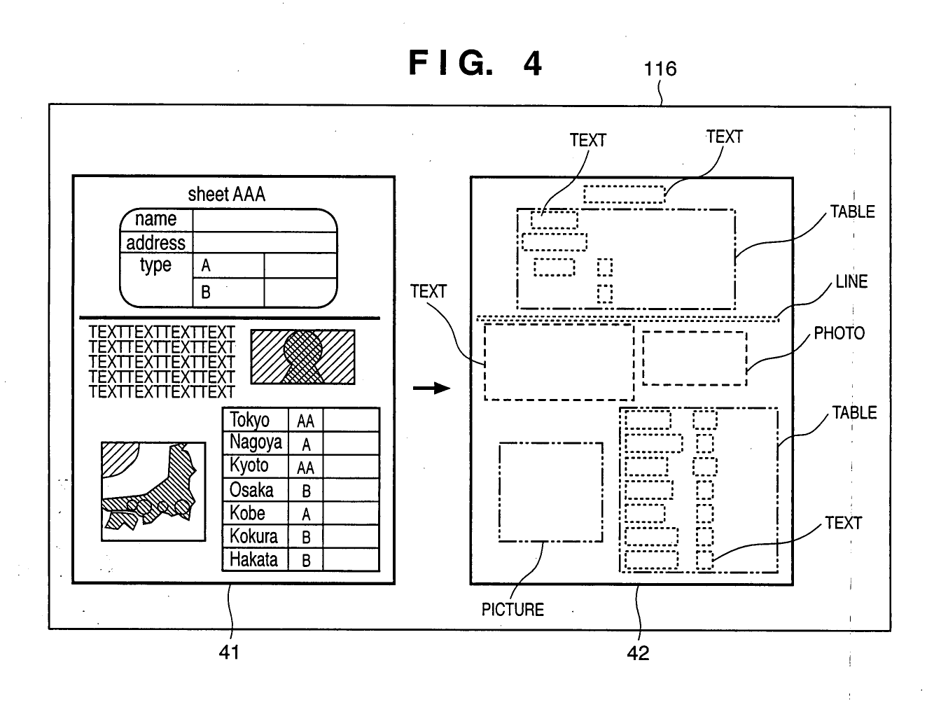

In step S302 (block selection step), as indicated by an image 42 on the right half portion of FIG. 4, the input image is segmented into rectangular blocks according to the properties. As described above, the properties of rectangular blocks include character (TEXT), drawing (PICTURE), line drawing (Line), table (Table), photograph (PHOTO), and the like.

In the block selection step, first of all, the input image is binarized into a monochrome image, and pixel clusters surrounded by black pixel outlines are extracted.

The sizes of the black pixel clusters extracted in this manner are evaluated, and outline tracing is performed with respect to the white pixel clusters inside black pixel clusters whose sizes are equal to or larger than a predetermined value. Evaluation of such white pixel clusters and tracing of inner black pixel clusters are then performed. In this manner, extraction and outline tracing of inner pixel clusters are recursively performed as long as the sizes of inner pixel clusters are equal to or larger than the predetermined value.

The size of a pixel cluster is evaluated by, for example, the area of the pixel cluster.

Rectangular blocks circumscribed to the pixel clusters obtained in this manner are generated, and the properties of the rectangular blocks are determined on the basis of the sizes and shapes of the blocks.

For example, a rectangular block whose aspect ratio is near 1 and size falls within a predetermined range is determined as a character corresponding block which can be a character region rectangular block. If adjacent character corresponding blocks are regularly arrayed, a new rectangular block containing these character corresponding blocks is generated as a character region rectangular block.

In addition, a flat pixel cluster is regarded as a line drawing region rectangular block, a black pixel cluster having a size equal to or larger than a predetermined size and containing a rectangular white pixel cluster is regarded as a table region rectangular block, a region in which pixel clusters having indefinite shapes are scattered is regarded as a photograph region rectangular block, and other pixel clusters having indefinite shapes are regarded as image region rectangular blocks.

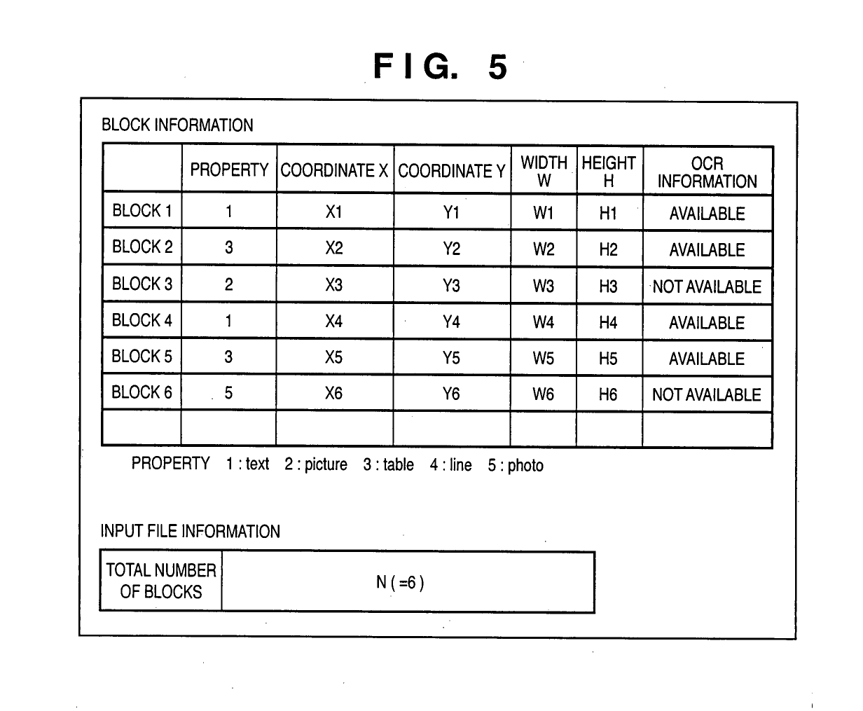

In the block selection step, for the respective rectangular blocks generated in this manner, block information such as properties and input file information like those shown in FIG. 5 are created.

Referring to FIG. 5, the block information includes the property, position coordinates X and Y, width W, height H, and OCR information of each block. The properties are given in the form of numerical values from 1 to 5, with 1 representing a character region rectangular block; 2, a graphic region rectangular block; 3, a table region rectangular block; 4, a line drawing region rectangular block; and 5, a photograph region rectangular block. The coordinates X and Y represent the X- and Y-coordinates of an initial point (the coordinates of the upper left corner) of each rectangular block in the input image. The width W and height H represent the width of a rectangular block in the X-coordinate direction and the height of the block in the Y-coordinate direction. The OCR information indicates the presence/absence of pointer information in the input image.

The input file information further includes a total number N of blocks representing the number of rectangular blocks.

The block information of each rectangular block is used for vectorization in a specific region. In addition, with the block information, a relative positional relationship can be specified when a specific region and other regions are to be combined. This makes it possible to combine a vectorized region and raster data region without impairing the layout of the input image.

[Pointer Information Extraction Step]

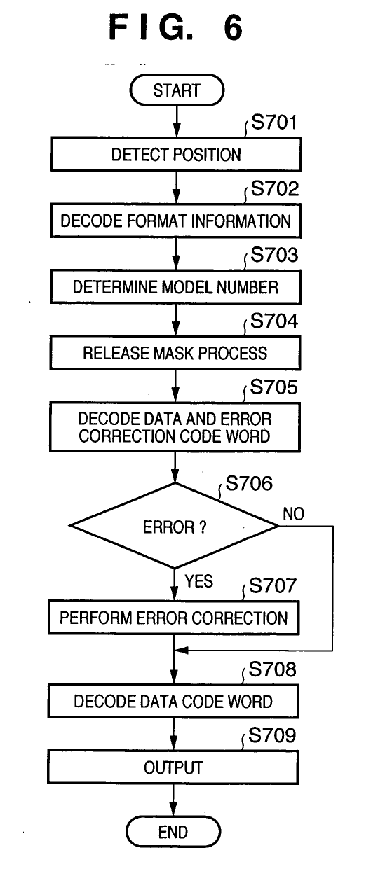

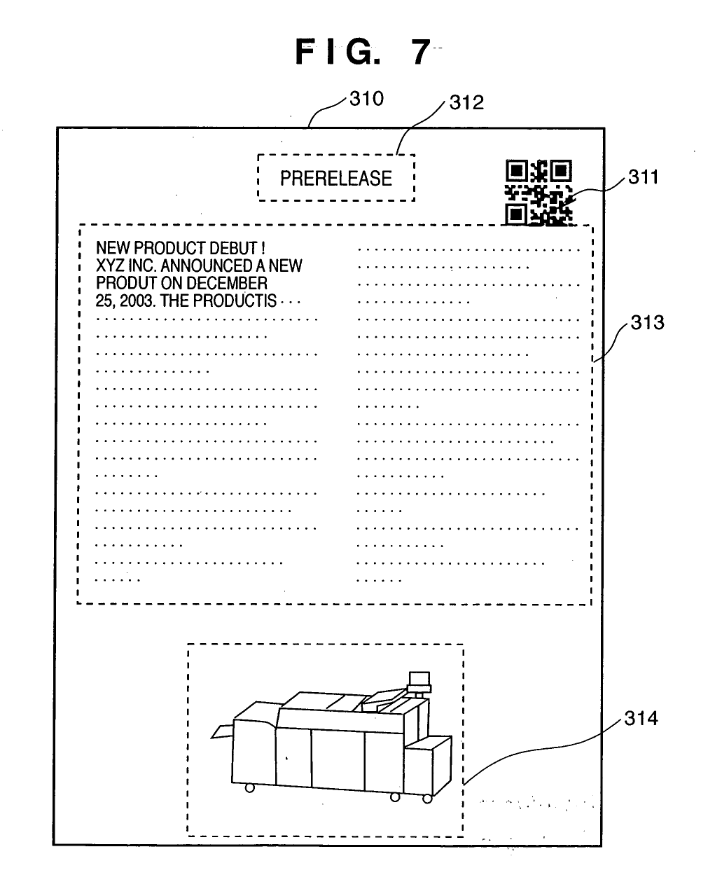

Step S307 (pointer information extraction step) is executed in the respective steps in FIG. 6. FIG. 7 shows an original 310 to be processed in the pointer information extraction step. The original 310 is stored in the page memory (not shown) in the data processing device 115. On the original 310, character region rectangular blocks 312 and 313, an image region rectangular block 314, and two-dimensional barcode (QR code) symbol 311 are printed.

Step S701: First of all, the input image of the original 310 stored in the page memory in the storage device 111 is scanned by a CPU (not shown) to detect the position of the two-dimensional barcode symbol 311 from the processing result obtained in the block selection step.

A QR code symbol has specific position detection element patterns provided at three corners of the four corners. By detecting the position detection element patterns, the QR code symbol can be detected.

Step S702: Format information adjacent to each position detection pattern is decoded to obtain an error correction level and mask pattern applied to the symbol.

Step S703: The model of the symbol is then determined.

Step S704: The encoded region bit pattern of the QR code is XORed by using the mask pattern obtained from the format information in step S702, thereby releasing the mask processing applied to the symbol of the QR code.

Step S705: A mapping rule is acquired on the basis of the model obtained in step S703. A symbol character is then read on the basis of this mapping rule to decode the data of a message and an error correction code word.

Step S706: The presence/absence of an error in the decoded message is detected on the basis of the error correction code word. If an error is detected, the flow branches to step S707 to correct the error.

Step S707: The decoded message is corrected.

Step S708: The data code word is segmented and decoded by using the error-corrected data on the basis of a mode indicator and character count indicator.

Step S709: A data code character is decoded on the basis of the detected specification mode, and the result is output.

The data incorporated in the two-dimensional barcode represents the pointer information of the original data file, and is composed of path information formed from, for example, a file server name and file name. Alternatively, this data is composed of a URL to the corresponding file, a file ID in the database 105 or storage device 111 in which the file is stored, or the like.

Although this embodiment has exemplified the original 310 for which the pointer information is provided in the form of a two-dimensional barcode, various printing forms can be used for the pointer information.

For example, the pointer information may be directly printed in the form of a character string complying with a predetermined rule, and the rectangular block of the character string may be detected in the block selection step. The pointer information can be acquired by recognizing the detected character string.

Alternatively, image data may be obtained by scanning the document which is printed out while embedding watermark information in the character region rectangular block 312 or character region rectangular block 313 by applying modulation that is difficult to visually recognize to the spacings between adjacent character strings. The pointer information can be expressed by the information of the character string spacing modulation from the image data. Such watermark information can be detected by detecting the spacings between the respective characters in a character recognition process (to be described later), and hence pointer information can be acquired. In addition, pointer information can be added as a digital watermark in the image region rectangular block 314.

[Digital File Search Using Pointer Information]

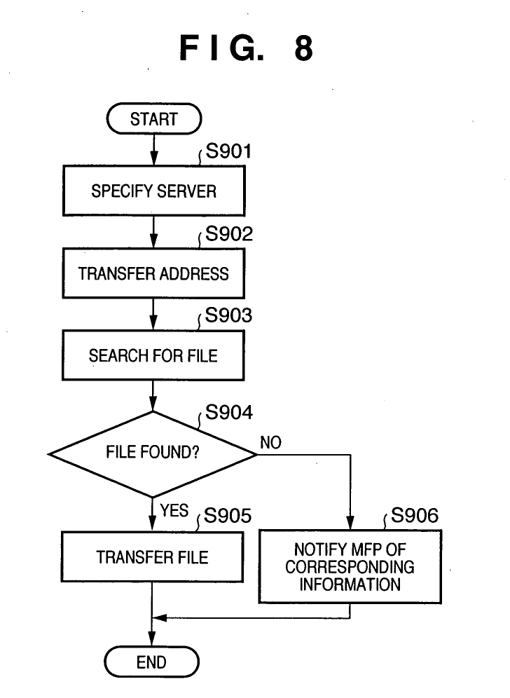

A digital file search using the pointer information in steps S308 and S311 in FIG. 3 is executed in the respective steps in FIG. 8.

Step S901: A file server is specified on the basis of the address contained in the pointer information. At least one of the client PC 102, the database 105, the document management server 106, and the MFP 100 incorporating the storage device 111 is used as a file server. The address is a URL or path information composed of a server name and file name.

Step S902: The address is transferred to the file server specified in step S901.

Step S903: The file server specified in step S901 receives the address transferred in step S902, and searches for an original data file on the basis of the address.

Step S904: It is checked whether or not an original data file can be extracted by the file search in step S903. If the file can be extracted, the flow advances to step S905. If the file cannot be extracted, the flow advances to step S906.

Step S905: As described with reference to FIG. 3, if the address of the file is notified to the MFP 100, and the user desires to acquire original file data, the original data file is transferred to the MFP 100. This terminates the processing.

Step S906: If no file can be extracted in step S903, corresponding information is notified to the MFP 100, and the processing is terminated.

[File Search Process]

The file search process in step S309 in FIG. 3 is executed if no pointer information is contained in the input image or no digital file can be extracted from the pointer information. The file search process is executed by a combination of a plurality of search methods including a keyword search process, full-text search process, layout search process, condition narrow-down search process, and the like.

In the keyword search process, a search key for image data as a search target is used to search an index file (exact or fuzzy matching) in which keywords associated with the respective digital files in the database are registered in advance.

Note that as a search key, the word manually input by the user in step S303, a word in the characters extracted from the input image by OCR processing in step S305, a word with a digital watermark, or the like is used.

In the full-text search process, the entire text information of the original data file is searched for by using the search key obtained in the keyword search process. The larger the number of extracted search keys, the higher the similarity is determined.

In the condition narrow-down search process, digital files are narrowed down on the basis of conditions including the size information, date information, and the like manually input in step S303.

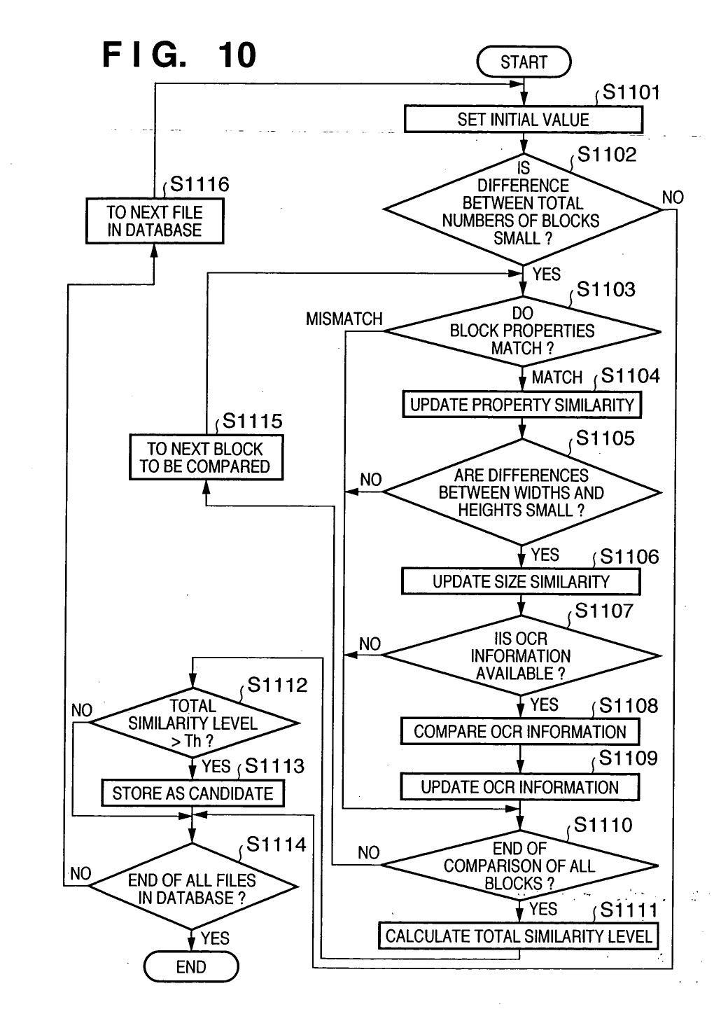

The layout search process will be described in detail with reference to FIG. 10.

[Layout Search Process]

The layout search process is executed in the respective steps in FIG. 10.

Assume that each rectangular block and input image data extracted in step S302 have block information and input file information like those shown in FIG. 5.

In the block information, for example, the rectangular blocks are arrayed in ascending order of coordinates X (blocks having identical X-coordinates are arrayed in ascending order of Y-coordinates), and the magnitude relation between the coordinates X of blocks 1, 2, 3, 4, 5, and 6 is represented by X1<=X2<=X3<=X4<=X5<=X6. The layout search process for files similar to the input image is executed in the database by using these pieces of information in the respective steps in FIG. 10. Assume that each database file has information similar to that in FIG. 5. According to the flow of the flow chart, block information and input file information are sequentially compared with files in the database.

Step S1101: The similarity and the like to be described later are initialized.

Step S1102: It is then checked whether there is any data file in which the difference from the total number N of blocks in the input image falls within a predetermined value, i.e., which has a-total number N of blocks satisfying N−ΔN<n<N+ΔN, among the data files in the database. If a data file matching the condition is searched for/extracted, the flow advances to step S1103 to sequentially compare the information of each rectangular block in the searched/extracted data file with each block in the input image. If the difference between the total number of blocks is large, the flow jumps to step S1114. In rectangular block information comparison, a property similarity level, size similarity level, and OCR similarity level are calculated in steps S1103 to S1109, and the total similarity level of the data file as the comparison target is calculated on the basis of these similarity levels in step S1111.

Step S1103: A block property of the input image is compared with a block property of the database file extracted in step S1102. If the block properties coincide with each other, the flow advances to step S1104. If the block properties do not coincide with each other, the flow advances to step S1110 to check whether or not comparison with respect to all the blocks of the input image is completed.

Step S1104: With regard to the properties of the block information which are compared in step S1103, the property similarity level is updated. As a method of calculating a property similarity level, an arbitrary method can be used. Assume that a property similarity level is calculated on the basis of ((the number of property match block)/(the total number of blocks)).

Step S1105: The size (width W, height H) of block information of the input image is compared with the size (width w, height h) of the database file extracted in step S1102. It is then checked whether or not the size difference falls within a predetermined range, i.e., W−ΔW<w<W+ΔW and H−ΔH<h<H+ΔH. If the size difference falls within the predetermined range, the flow advances to step S1106. If the size difference falls outside the predetermined range, the flow advances to step S1110 to check whether comparison with respect to all the blocks of the input image is completed.

Step S1106: With regard to the sizes of the block information which are compared in step S1105, the size similarity level is updated. As a method of calculating a size similarity level, an arbitrary method can be used. For example, the size similarity level of each block is obtained according to {1−(size difference)/(the block size of input image data)}, and the average value of the size similarity levels with respect to the data file is obtained, thereby calculating a size similarity level.

Step S1107: It is checked whether or not OCR information is “available” in block information of the input image and the block information of the data file extracted in step S1102. If OCR information is “available” in both pieces of information, the flow advances to step S1108. If OCR information is “not available”, the flow advances to step S1110 to check whether or not comparison with respect to all the-block of the input image is completed.

Step S1108: The OCR information of block information of the input image is compared with the OCR information of the data file extracted in step S1102.

Step S1109: With regard to the OCR information compared in step S1108, an OCR information similarity level is calculated. As a method of calculating an OCR information similarity level, an arbitrary method can be used. For example, the recognition result characters of the respective blocks are compared, and the coincidence ratio of the recognition results is obtained, thereby obtaining an OCR information similarity level.

Step S1110: It is checked whether or not comparison processing between all the blocks contained in the input image and the respective blocks of the corresponding data files is completed. If the processing of all the rectangular blocks is completed, the flow advances to step S1111. If there is any unprocessed rectangular block, the flow returns to step S1103 via step S1115 to perform comparison processing of the next block.

Step S1111: A total similarity level is calculated on the basis of a property similarity level, size similarity level, and OCR similarity level. For example, a total similarity level is calculated by assigning predetermined weights to the respective similarity levels and calculating their sum.

Step S1112:. It is checked whether or not the total similarity level is higher than a predetermined threshold value Th. If the total similarity level is higher than the threshold value Th, the flow advances to step S1113. If the total similarity level is equal to or lower than the threshold value Th, the flow advances to step S1114.

Step S1113: A data file in the database for which it is determined in step S1112 that the total similarity level is higher than the threshold value is stored as a similar candidate.

Step S1114: It is checked whether or not the processing of all the data files in the database is completed. If the processing of all the database files is completed, the processing is immediately terminated. If there is any unprocessed database file, the flow returns to step S1101 via step S1116.

Step S1115: In order to compare each block information of the data file with all pieces of block information of the input image, a comparison target block is shifted to the next block.

Step S1116: In order to sequentially compare the respective data files in the database, the next data file is set as a comparison target.

In each step shown in FIG. 10, let N, W, and H be the total number of blocks of the input image, each block width, and each block height, respectively, and ΔN, ΔW, and ΔH represent allowable ranges with reference to the block information of the input image. Let n, w, and h be the total number of blocks of a database file, each block width, and each block height, respectively.

Although not shown, when size comparison is done in step S1105, the positional information of the coordinates X and Y may be compared.

Each of the search results obtained by the above search schemes is numerically converted into a similarity score, and the final search result which is the sum of the respective scores assigned with weights is evaluated as a total search similarity. The weighting method to be used may be a method of assigning a heavy weight to the search result based on the information input in step S303, or assigning a heavy weight to a score regarded as significant on the basis of statistical processing of past search results, or providing a user interface for weight input operation to allow the user to arbitrarily set a weight.

The total search similarity is compared with a predetermined threshold value. Any digital file exhibiting a score higher than the threshold value is set as a search target candidate. If a plurality of candidates are extracted, candidate selection processing is performed in step S310.

[Vectorization Step]

In step S312 (vectorization step), if the original data file does not exist in the file server, image data 41 in FIG. 4 is vectorized for each rectangular block. If a rectangular block is a character region rectangular block, a character recognition process is executed for each vectorized character.

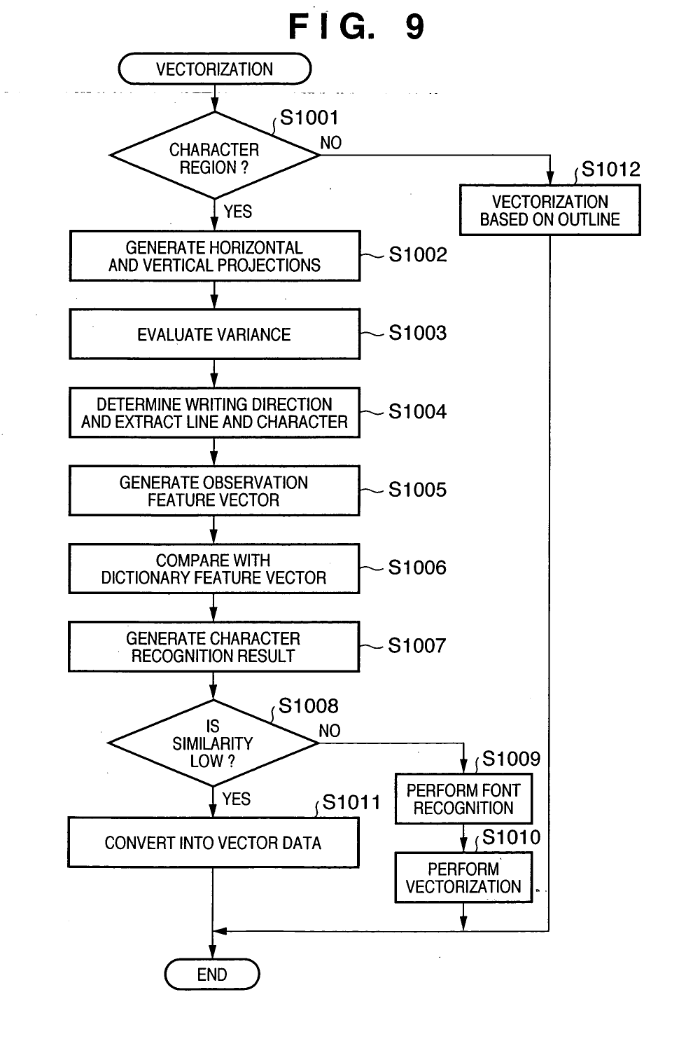

A vectorization process is executed in the respective steps in FIG. 9.

Step S1001: It is checked whether or not a specific region is a character region rectangular block. If the region is a character region rectangular block, the flow advances to step S1002 to perform recognition by using a pattern matching technique to obtain a corresponding character code. If the specific region is not a character region rectangular block, the flow shifts to the processing in step S1012.

Step S1002: For the sake of determination of horizontal/vertical writing direction with respect to a specific region (writing direction determination), the horizontal and vertical projections of the pixel values in the specific region are calculated.

Step S1003: The projection variances obtained in step S1002 are evaluated. If the horizontal projection variance is larger, horizontal writing is determined. If the vertical projection variance is larger, vertical writing is determined.

Step S1004: A writing direction is determined on the basis of the evaluation result obtained in step S1003. Thereafter, lines are extracted, and characters are then extracted to obtain a character image.

In decomposing the region into character strings and characters, in the case of horizontal writing, a line is extracted by using the projection in the horizontal direction, and characters are extracted by using the vertical projection of the extracted line. With respect to a character region for vertical writing, processing reverse to that for horizontal writing is performed. In extracting lines and characters, the size of each character can also be detected.

Step S1005: For each character extracted in step S1004, an observation feature vector obtained by converting a feature acquired from that character image into a several-ten-dimensional numerical value string is generated. Various known methods are available for feature vector extraction. For example, a method of dividing a character into a mesh pattern, and counting character lines in respective meshes as line elements depending on their directions to obtain a (mesh count)-dimensional vector as a feature is known.

Step S1006: The observation feature vector obtained in step S1005 is compared with the dictionary feature vector obtained in advance for each character type to calculate the distance between the observation feature vector and the dictionary feature vector.

Step S1007: The distances calculated in step S1006 are evaluated, and the character type exhibiting the shortest distance is regarded as a recognition result.

Step S1008: In distance evaluation in step S1007, it is checked whether or not the shortest distance is larger than a predetermined value. If the distance is equal to or larger than the predetermined value, it is highly possible that another character similar in shape to the character represented by the dictionary feature vector is erroneously recognized. If, therefore, the distance is equal to or larger than the predetermined value, the recognition result obtained in step S1007 is not used, and the flow advances to the processing in step S1011. If the distance is smaller than predetermined value, the recognition result obtained in step S1007 is used, and the flow advances to step S1009.

Step S1009 (font recognition step): A plurality of sets of dictionary feature vectors for the number of character types used in character recognition are prepared in correspondence with character shape types, i.e., font types, and a font type is output together with a character code upon matching, thus recognizing a character font.

Step S1010: Each character is converted into vector data by using the character code and font information obtained by character recognition and font recognition and outline data prepared for each character. Note that if an input image is a color image, the color of each character is extracted from the color image and printed together with vector data.

Step S1011: Each character is processed in the same manner as a general line drawing to be outlined. That is, for a character which tends to be erroneously recognized, the vector data of an outline visually faithful to the image data is created.

Step S1012: If the specific region is not a character region rectangular block, a vectorization process is executed on the basis of the outline of the image.

With the above process, the image information belonging to the character region rectangular block can be converted into vector data almost faithful in shape, size, and color.

[Vectorization of Regions Other than Character Regions]

If the region other than a character region rectangular block in step S1012 is determined as a drawing region rectangular block, line drawing region rectangular block, table region rectangular block, or the like, the outline of a black pixel cluster extracted in the specific region is converted into vector data.

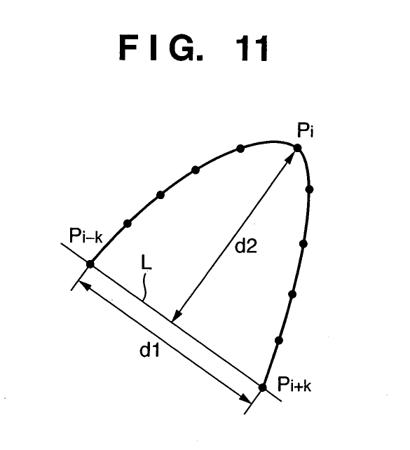

In vectorizing a region other than a character region, first of all, in order to express a line drawing or the like as a combination of lines and/or curves, a “corner” which segments a curve into a plurality of intervals (pixel strings) is detected. A corner is a point where the curvature is maximized. Whether or not a pixel PI on curve in FIG. 11 is a corner is determined in the following manner.

Pixels Pi−k and Pi+k which are separated from the pixel Pi as a start point by a predetermined number of pixels (k pixels) in two directions, respectively, along the curve are connected with a line segment L. Letting d1 be the distance between the pixels Pi−k and Pi+k, d2 be the distance between the line segment L and the pixel Pi, and A be the length of the arc of the curve between the pixels Pi−k and Pi+k, the pixel Pi is then determined as a corner if the distance d2 is maximized or the ratio (d1/A) becomes equal to or lower than a threshold value.

The pixel strings segmented by the corner are approximated by a straight line or curve. The approximation to a straight line is execute by the least squares method or the like. The approximation to a curve is executed by using a cubic spline function or the like. A pixel as a corner which segments a pixel string is located at the start or end point of an approximate straight line or curve.

It is further checked whether or not the inner outline of a white pixel cluster exists in the vectorized outline. If the inner outline exists, the outline is vectorized. The inner outline of inverted pixels is recursively vectorized such that the inner outline of another inner outline is vectorized.

As described above, by using separatrix approximation of an outline, the outline of a graphic having an arbitrary shape can be vectorized. If the original is color, the color of the graphic is extracted from the color image and printed together with vector data.

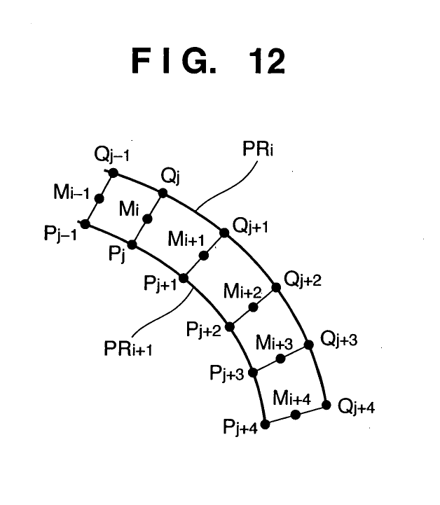

As shown in FIG. 12, if an outer outline PRj and an inner outline PRj+1 or another outer outline are located close to each other within a given interval of interest, the two or more outline lines can be combined to be expressed as a line having a thickness. Assume that a distance PiQi from each pixel Pi on an outline Pj+1 to a pixel Qi on an outline PRj which is located at the shortest distance is calculated. In this case, if variations in PiQi are small, the interval of interest can be approximated by a straight line or curve extending along a point string of middle points Mi between the pixels Pi and Qi. The thickness of the approximate straight line or curve is set to, for example, the average value of the distances PiQi.

If lines or ruled lines of a table which are an aggregate of lines are an aggregate of lines having a thickness, they can be efficiently expressed by vectors.

After the outlines are combined, the overall processing is terminated.

Note that a photograph region rectangular block is made to remain as image data without being vectorized.

[Graphic Recognition]

After the above outlines of line drawings and the like are vectorized, the vectorized separatrices are grouped for each graphic object.

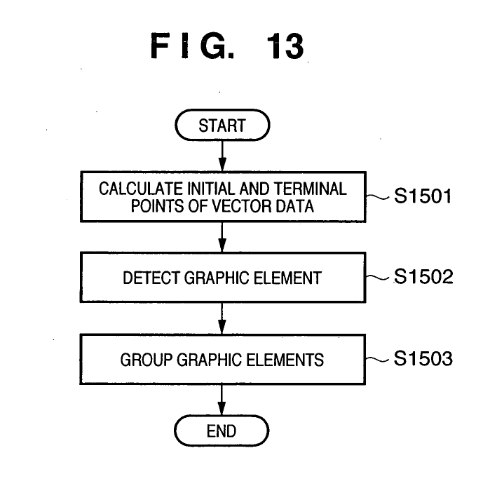

The steps in FIG. 13 indicate-the processing of grouping vector data for each graphic object.

Step S1501: First of all, the initial point and terminal point of each vector data are calculated.

Step S1502 (graphic element detection): A graphic element is detected by using the initial point information and terminal point information obtained in step S1501. A graphic element is a closed graphic composed of separatrices. In detecting such an element, terminal points of concatenated vectors are detected near the start and terminal points. That is, this technique uses the principle that each vector forming a closed shape has vectors concatenated to its two ends.

Step S1503: Other graphic elements or separatrices existing in the graphic element are grouped into one graphic object. If there are no other graphic elements or separatrices in the graphic element, it is regarded as a graphic object.

[Detection of Graphic Element]

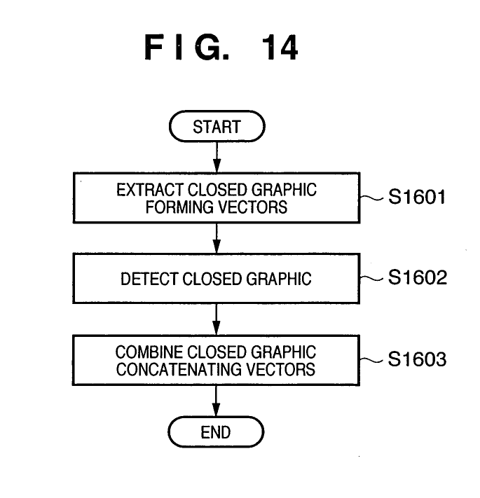

The processing in step S1502 (graphic element detection) is executed in the respective steps in FIG. 14.

Step S1601: First of all, unnecessary vectors which are not concatenated to two ends of a vector are removed from the vector data to extract vectors constituting a closed graphic.

Step S1602: An end point (the start or terminal point) of one of the vectors constituting the closed graphic is set as a start point, and vectors are sequentially searched in a predetermined direction, e.g., clockwise. That is, at the other end point, an end point of another vector is searched for, and the nearest end point within a predetermined distance is set as an end point of a concatenated vector. When the searching point makes a round around the vectors constituting the closed graphic and returns to the start point, all the vectors which the searching point has passed are grouped as a closed graphic forming one graphic element. In addition, all the closed graphic forming vectors inside the closed graphic are also grouped. Furthermore, the initial point of a vector which has not been grouped is set as a start point, and similar processing is repeated.

Step S1603: Finally, of the unnecessary vectors removed in step S1601, vectors whose end points are located close to the vectors grouped as a closed graphic in step S1602 are detected and grouped as one graphic element.

The above processing makes it possible to handle graphic blocks as individual graphic objects that can be reused.

The necessity to perform the above vectorization process for an entire input image is generally low. In many cases, it suffices if such processing is performed for only the specific region designated by the user.

Performing a vectorization process for only the specific region designated by the user can improve the performance of processing, and efficiently vectorize only the portion desired by the user to allow the resultant data for a search process in the next step. Alternatively, this can provide the effect of re-editing/re-using only necessary part of image information.

(Conversion to Application Data]

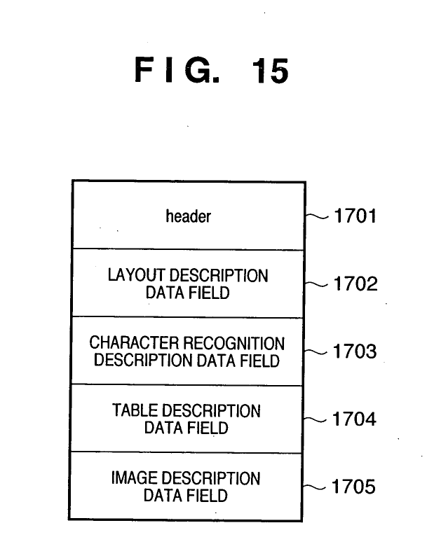

After the block selection step (step S304) in FIG. 3, conversion to application data in step S313 is executed by using the data obtained by vectorization (step S312). The vectorization process result in step S312 is stored in the intermediate data format shown in FIG. 15, i.e., the so-called document analysis output format (DAOF).

Referring to FIG. 15, DAOF is comprised of a header 1701, layout description data field 1702, character recognition description data field 1703, table description data field 1704, and image description data field 1705.

The header 1701 holds information about an input image to be processed.

The layout description data field 1702 holds the properties of the rectangular blocks in the input image, including TEX (character), TITLE (title), CAPTION (caption), LINE (line drawing), PICTURE (image), FRAME (frame), TABLE (table), PHOTO (photograph), and the like, and pieces of positional information of the respective rectangular blocks from which these properties are recognized.

The character recognition description data field 1703 holds the character recognition results obtained by character-recognizing character region rectangular blocks such as TEXT, TITLE, and CAPTION.

The table description data field 1704 holds the details of the table structure of a table region rectangular block TABLE.

The image description data field 1705 holds image data in blocks such as a drawing region rectangular block PICTURE and line drawing rectangular block LINE which are extracted from the input image data.

Such DAOF data is itself sometimes filed and stored as well as being stored as intermediate data. This data in the file state cannot be reused in an object in general document creation application software. For this reason, DAOF is converted into application data.

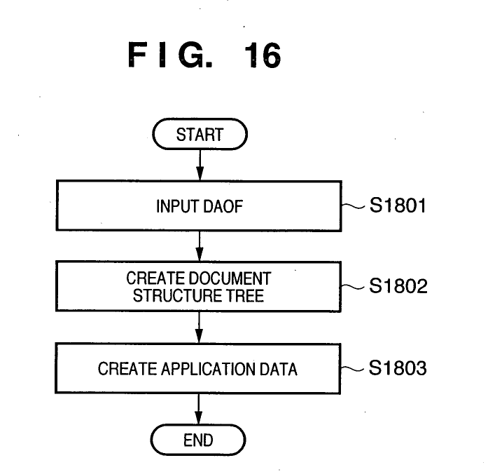

Conversion to application data is executed in the respective steps in FIG. 16.

Step S1801: Data in the DAOF is input.

Step S1802: A document structure tree as a source for application data is created.

Step S1803: The live data in DAOF is acquired on the basis of the document structure tree to create actual application data.

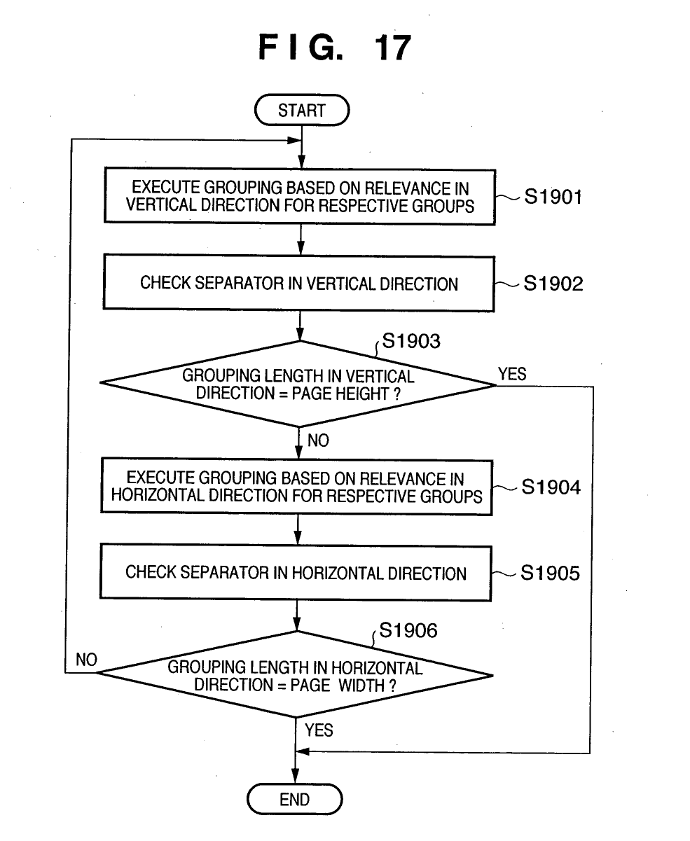

The document structure tree creation process in step S1803 is executed in the respective steps in FIG. 17. According to the basic rule of overall control in the processing in FIG. 17, the flow of processing shifts from a microblock (single rectangular block) to a macroblock (an aggregate of rectangular blocks). Assume that a “rectangular block” means both a microblock and a macroblock.

Step S1901: Rectangular blocks are re-grouped on a rectangular block basis on the basis of relevance in the vertical direction. Although the processing in FIG. 17 is sometimes executed repeatedly, determination is performed on a microblock basis immediately after the initial of the processing.

In this case, “relevance” is defined by features such as “close distance” and “similar block widths (heights in the horizontal direction)”. In addition, information such as distance, width, and height is extracted by referring to DAOF.

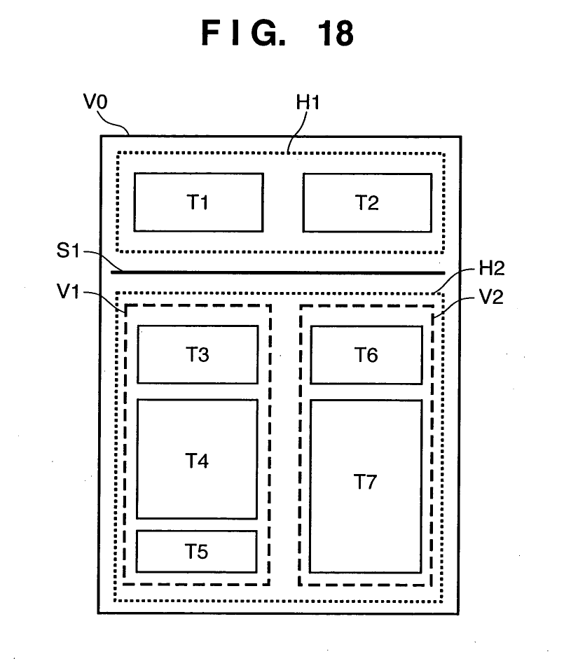

In the input image shown in FIG. 18, rectangular blocks T1 and T2 are arranged side by side in the horizontal direction in the uppermost portion. A horizontal separator S1 exists below the rectangular blocks T1 and T2, and rectangular blocks T3, T4, T5, T6, and T7 exist below the horizontal separator S1.

The rectangular blocks T3, T4, and T5 are vertically arranged from top down in the left half portion of the region below the horizontal separator S1. The rectangular blocks T6 and T7 are arranged above and below in the right half portion of the region below the horizontal separator S1.

Grouping is executed on the basis of relevance in the vertical direction in step S1901. This combines the rectangular blocks T3, T4, and T5 into one group (rectangular block) V1, and combines the rectangular blocks T6 and Y7 into one group (rectangular block) V2. The groups V1 and V2 are located on the same level.

Step S1902: The presence/absence of a vertical separator is checked. A separator in DAOF is an object having a line property, and has a function of explicitly separating blocks in application software. When a separator is detected, the regions of the input image are horizontally separated on the level where processing is to be performed. There is no vertical separator in the image shown in FIG. 18.

Step S1903: It is checked whether or not the sum of group heights in the vertical direction becomes equal to the height of the input image. Assume that grouping in the horizontal direction is performed while the region to be processed is moved in the vertical direction (e.g., from top to bottom). In this case, when processing of the entire input image is completed, the sum of the group heights becomes equal to the height of the input image. By using this phenomenon, the end of the processing is determined. If grouping is completed, the processing is immediately terminated. If grouping is not completed, the flow advances to step S1904.

Step S1904: A grouping process based on relevance in the horizontal direction is executed. This combines the rectangular blocks T1 and T2 into one group (rectangular block) H1, and combines the rectangular blocks V1 and V2 into one group (rectangular block) H2. The groups H1 and H2 are located on the same level. In this case as well, determination is performed on a microblock basis immediately after the start of the processing.

Step S1905: The presence/absence of a horizontal separator is checked. When a separator is detected, the regions of the input image are vertically separated on the level where processing is to be performed. The horizontal separator S1 exists in the image shown in FIG. 18.

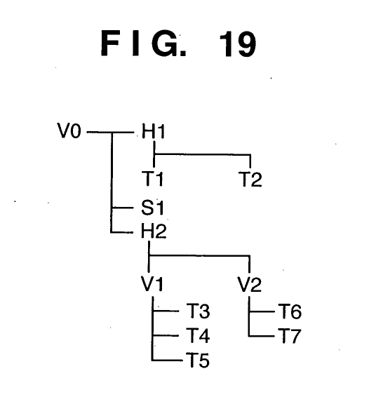

The above processing result is registered as the tree shown in FIG. 19.

Referring to FIG. 19, an input image V0 includes the groups H1 and H2 and separator S1 on the uppermost level, and the rectangular blocks T1 and T2 on the second level belong to the group H1.

The groups V1 and V2 on the second level belong to the group H2. The rectangular blocks T3, T4, and T5 on the third level belong to the group V1. The rectangular blocks T6 and T7 on the third level belong to the group V2.

Step S1906: It is checked whether or not the sum of group lengths in the horizontal direction becomes equal to the width of the input image. With this operation, termination decision on grouping in the horizontal direction is performed. If the group length in the horizontal direction is equal to the page width, the processing of document structure tree creation is terminated. If the group length in the horizontal direction is not equal to the page width, the flow returns to step S1901 to repeat processing from a relevance check in the vertical direction on a level one level higher than the current level.

When the tree structure shown in FIGS. 18 and 19 is created, since the division width in the horizontal direction becomes equal to the page width, the processing is immediately terminated. Finally, V0 on the uppermost level which indicates the overall page is added to the document structure tree.

After the document structure tree is completed, application data is created on the basis of the information of the tree in step S1803.

The following is an example of the processing executed by application software using the application data based on the tree shown in FIGS. 18 and 19.

First of all, since the group H1 has the two rectangular blocks T1 and T2, two columns are set, and the internal information of T1 (the sentence, image, or the like obtained as a result of character recognition) is output by referring to DAOF of T1. Thereafter, a new column is set to the other one, and the internal information of T2 is output. The separator S1 is then output.

The flow shifts to the processing of the next group H2. Since the group H2 has the two rectangular blocks V1 and V2 in the horizontal direction, the information is output as two columns. With regard to the group V1, the pieces of internal information of the rectangular blocks T3, T4, and T5 are sequentially output in the order named. Thereafter, a new column is set, and the internal information of the rectangular blocks T6 and T7 of the group V2 is output.

Conversion to application data is executed in the above manner.

[Addition of Pointer Information]

The pointer information addition process in step S318 is the processing of adding pointer information to a printing sheet upon printing the extracted or created file. A digital file can be easily extracted by referring to the pointer information.

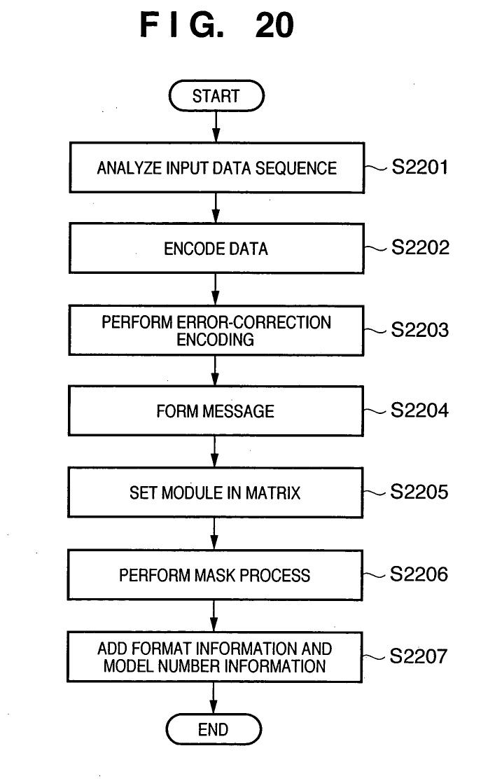

The processing of adding pointer information as a two-dimensional barcode (QR code symbol based on JIS X0510 or the like) will be described below with reference to the flow chart of FIG. 20.

Note that the two-dimensional barcode includes information that indicates a location from which a corresponding digital file can be acquired, as described with reference to FIG. 7.

Step S2201: Pointer information is analyzed by identifying characters that represent the pointer information to be converted into a QR code symbol, error detection and error correction levels are set, and a minimum model number that can store the pointer information is selected.

Step S2202: The pointer information analyzed in step S2201 is converted into a predetermined bit string, and an indicator indicating a mode (numeric, alphanumeric, 8 bits per byte, kanji, etc.) and an end pattern are added as needed. Furthermore, the bit string obtained in this manner is converted into bit code words.

Step S2203: The bit code word string generated in step S2202 is segmented into a predetermined number of blocks in accordance with the model number and error correction level, and-error correction code words are generated for respective blocks. Furthermore, the error correction code words are added after the bit code word string.

Step S2204: The bit code words of the respective blocks generated in step S2203 are connected, and error correction code words are added to the respective blocks. Furthermore, remainder code words are added after the correction codes of the respective blocks as needed. In this manner, a code word module is generated.

Step S2205: A position detection pattern, a separation pattern, a timing pattern, an alignment pattern, and the code word module are set in a predetermined matrix.

Step S2206: A mask pattern optimal to the symbol encoding region in the matrix generated in step S2205 is selected, and a module is generated by calculating XORs of the matrix and mask pattern.

Step S2207: Format information and model number information are generated for the module generated in step S2206, thus completing a QR code symbol.

The QR code symbol that incorporates the address information is converted into printable raster data by the data processing device 115 and is formed as an image at a predetermined position of a printed image upon printing a digital file by the MFP 100 in response to a request from the client PC 102.

As has been explained in association with step S306, since the printed image formed is read by the image scanning unit 110, pointer information can be acquired, and the storage location of the digital file can be detected.

The above embodiment has exemplified the processing of the input image input from the image scanning unit 110 or the like. However, the present invention is also effective for image data other than the input image such as image data consisting of raster data or its encoded data stored in a storage medium, image data supplied by a communication means, and the like.

A means for practicing the image processing method according to the present invention is not limited to the image processing system shown in FIGS. 1 and 2, and various other means such as a dedicated image processing apparatus, versatile computer, and the like may be adopted.

In practicing the method of the present invention using a versatile computer, the versatile computer loads a computer executable program that includes a program code which makes the versatile computer execute the respective steps of the image processing method.

The program that makes the versatile computer execute the image process is loaded from a ROM built in that versatile computer or a storage medium that can be read by the versatile computer, or is loaded from a server or the like via a network.

It is to be understood by those skilled in the art that the spirit and scope of the present invention are not limited to the specific description and drawings of the invention, and the contents described in the appended claims can be variously modified and changed.

What is claimed is:

1. An image processing method for search for an, original data file corresponding to an input image, comprising the steps of:
(a) acquiring first search information associated with the input image on the basis of information input by a user;
(b) acquiring feature data contained in the input image as second search information; and
(c) searching for an original data file corresponding to the input image by using the first and second search information.

2. The method according to claim 1, further comprising the step of:
(d) registering the first search information as an index for searching for the original data file in an index file.

3. The method according to claim 1, wherein the first search information comprises a keyword for search.

4. The method according to claim. 1, wherein the first search information comprises a data size of the original data file.

5. The method according to claim 1, wherein the first search information comprises date information of the original data file.

6. The method according to claim 1, wherein the second search information comprises information associated with a storage location of the original data file which is extracted on the basis of pointer information in the input image.

7. The method according to claim 1, wherein the second search information comprises a character code of a character recognition result which is obtained by performing a character recognition process with respect to a character region in the input image.

8. The method according to claim 1, wherein the second search information comprises feature data of each block obtained by region segmentation of the input image.

9. The method according to claim 1, further comprising the step of:
(e) converting the input image into vector data when no original data file can be searched in the step (c).

10. The method according to claim 9, further comprising the step of:
(f) converting the input image, which has been converted into the vector data, into data in a format which can be handled by application software.

11. The method according to claim 9, further comprising the step of:
(g) storing the input image which has been converted into the vector data in a database.

12. The method according to claim 10, further comprising the step of:
(h) registering the first search information, in an index file, as an index for searching for an image represented by vector data stored in a database in the step (c).

13. The method according to claim 1, further comprising the step of:
(i) outputting the searched original data, wherein pointer information is added to the output original data file.

14. The method according to claim 13, wherein the pointer information is added as a digital watermark to the original data file.

15. The method according to claim 1, wherein in the step (c), the original data file is searched for by using at least one of keyword search, full-text search, and layout search.

16. An image processing system which searches for an original data file corresponding to an input image, comprising:
means for acquiring first search information associated with the input image on the basis of information input by a user;
means for acquiring feature data contained in the input image as second search information; and
means for searching for an original data file corresponding to the input image by using the first and second search information.

17. A computer executable program stored on a computer-readable medium for search for an original data file corresponding to an input image, comprising:
code for acquiring first search information associated with the input image on the basis of information input by a user;
code for acquiring feature data contained in the input image as second search information; and
code for searching for an original data file corresponding to the input image by using the first and second search information.

18. A computer-readable medium having a computer executable program stored thereon for search for an original data file corresponding to an input image, the program comprising:
code for acquiring first search information associated with the input image on the basis of information input by a user;
code for acquiring feature data contained in the input image as second search information; and
code for searching for an original data file corresponding to the input image by using the first and second search information.
